(19) United States
(12) Patent Application Publication
(10) Pub. No.: US 2008/0152861 A1
(43) Pub. Date: Jun. 26, 2008

(54) Engineered Wood Composites Having Superior Strength and Stiffness

(75) Inventor: Joel Barker, Townville, SC (US)

Correspondence Address: J M HUBER CORPORATION, 333 THORNALL STREET, PATENT DEPARTMENT, EDISON, NJ, 08837-2220, US

(73) Assignee: HUBER ENGINEERED WOODS LLC, Charlotte, NC (US)

(21) Appl. No.: 11/614,237

(22) Filed: Dec. 21, 2006

(51) Int. Cl. B32B 5/12; D21B 1/04

(52) U.S. Cl. 428/106; 264/115

(57) ABSTRACT

Disclosed is a process for making an engineered wood product comprising the following steps: (a) cutting a quantity of strands from wood lumber by use of a 3D stranding process, the strands having a length of about 6 inches to about 12 inches; and (b) forming the quantity of strands into an engineered wood product.

### BACKGROUND OF THE INVENTION

Wood has been used by builders and craftsman for a wide variety of structural and aesthetic applications. Even today, after the development of advanced metallic, polymeric and composite materials, wood remains one of the most widely used structural materials because of its excellent strength and stiffness, pleasing aesthetics, good insulation properties and easy workability. However, in recent years the cost of solid timber wood has increased dramatically as its supply shrinks due to the gradual depletion of old-growth and virgin forests. Moreover, wood is an expensive material because less than half of harvested timber wood is converted to natural solid wood lumber, the remainder being discarded as scrap.

Accordingly, because of both the cost of high-grade timber wood as well as a heightened emphasis on conserving natural resources, wood-based alternatives to natural solid wood lumber have been developed that make more efficient use of harvested wood and reduce the amount of wood discarded as scrap. Plywood, particle board, oriented strand board (“OSB”), and oriented strand lumber (“OSL”) are just a few examples of wood-based composite alternatives to natural solid wood lumber, which make more efficient use of harvested wood, and have replaced natural solid wood lumber in many structural applications in the last seventy-five years. Indeed, while conventional solid wood lumber which has a fiber utilization rate of no higher than 40%, wood composite materials use between 75% to 95% wood fiber.

However, while these wood composite materials make excellent use of the available wood fiber supply, many wood composite materials have strength and stiffness properties that are inferior to solid wood lumber. This makes them unsuitable for use in many structural applications, including rimboard and I joist webstock material. Accordingly, specialized wood composite materials have been developed with enhanced strength and stiffness performance, including laminated strand lumber (“LSL”), oriented strand lumber (“OSL”).

This improved strength and stiffness performance can be explained as follows: most wood composite materials have their strands oriented along preferred directions, for example OSB often consists of three layers of wood strands, with the strands in the core layer oriented substantially along a first reference direction (e.g., the “machine direction” or the direction parallel to the conveyor on which the OSB is being formed) and the strands in adjacent surface layers oriented substantially perpendicularly to the first reference direction. This combination of perpendicularly oriented layers is an important factor in determining the properties of the wood composite board. However, just as important as these reference orientations is the mean deviations of the individual strand orientations from their reference orientation upon which they are intended to be aligned. If the mean deviation is very small (e.g., less than 10°) then the wood composite material will have better strength performance. LSL and OSL owe their superior strength performance, at least in part, because of the very small mean deviation in the strands with respect to their reference direction. For example, LSL has a MOE of between and 1.3 to 1.9 mmpi, while for OSB and plywood, the MOE values are much lower: from about 0.1 to about 0.5 mmpsi (depending in what direction the MOE is measured).

Thus, there has long been a need among wood composite material manufacturers to develop techniques to reduce the mean deviations of the individual strand orientations from their reference orientation. The most commonly used technique for orienting strands along a preferred direction is by using adjacently-spaced orienters. By narrowing the spacing between adjacent orienters, the direction along which the strands are oriented will be more uniformly controlled. However, by narrowing this spacing, it makes more it more difficult for the strands to fall through the orienters reducing through-put and causing “strand plugging”, which occurs when strands become lodged across the space between adjacent orienters thus preventing further strands from falling through, as well. (This is particularly a problem for LSL and OSL materials which tend to use longer strands—the longer strands contributing to the strength performance of the material).

One approach to this problem has been to develop special technology and devices to prevent strand plugging and increase throughput. Such devices include orienters that have a vibrator action, or utilize rotation or oscillation effects to reduce plugging and increase throughput. While these devices may indeed reduce plugging and increase throughput they do little or nothing to improve the strand orientation. The addition of special compression rollers adapted for use in the orientation process has been proposed to improve strand orientation (see e.g., U.S. Pat. No. 4,505,868), but has not met with widespread success. Moreover, while multi-deck orienters are effective at improving strand orientation and so have been widely adopted, these orienters are far better for making OSB (with its smaller strands of between 0.5 to 3 inches) than for making the long-strand OSL or LSL materials, which in fact can cause strand plugging in the multi-deck orienter configuration. More recent improvements to the technology of strand orientation include the use of disk-type on enters in which pluralities of intermeshed rotating discs on a plurality of substantially parallel side-by-side shafts have been widely adopted in the OSB industry. However, again this technology is not applicable to making OSL and LSL because OSL and LSL-sized strands are likely to cause large amounts of strand plugging which will reduce the throughput.

Given the aforementioned difficulties in designing machines for producing OSL and LSL wood composite materials, other manufactures have taken a different approach to improving orientation by more precisely selecting and sorting the strands so that the strands are pre-screened to be within a certain size and dimension. For example, U.S. Pat. No. 4,706,799 and other related U.S. patents, describe a method using pre-screened rod or needle-like strand/veneer technology to make PSL parallel strand lumber, which is similar to OSL and LSL. In this case, the strands were essentially long veneers strips of 4 to 8 feet long and ¾ to 1 inch wide with relatively uniform cross-sections; by specially selecting and sorting the strands then the technology disclosed in the above patents could be used to achieve excellent orientation results. However, a sorting and screening approach is far from optimal for making OSL or LSL because it is not particularly suitable for aligning OSL and LSL flakes and because the process requires that a significant number of strands be discarded and so results in poor fiber utilization rates.

Given the foregoing there is a need in the art for a process for producing OSL or LSL products with sufficiently high throughput and fiber utilization rates.

### BRIEF SUMMARY OF THE INVENTION

The present invention relates to a process for making an engineered wood product comprising the following steps: (a) cutting a quantity of strands from wood lumber by use of a 3D stranding process, the strands having a length of about 6 inches to about 12 inches; and (b) forming the quantity of strands into an engineered wood product.

### DETAILED DESCRIPTION OF THE INVENTION

All parts, percentages and ratios used herein are expressed by weight unless otherwise specified. All documents cited herein are incorporated by reference.

As used herein, “wood” is intended to mean a cellular structure, having cell walls composed of cellulose and hemicellulose fibers bonded together by lignin polymer.

By “wood composite material” or “wood composite component” it is meant a composite material that comprises wood and one or more other additives, such as adhesives or waxes. Non-limiting examples of wood composite materials include oriented strand board (“OSB”), structural composite lumber (“SCL”), waferboard, particle board, chipboard, medium-density fiberboard, plywood, laminated strand lumber (“LSL”), oriented strand lumber (“OSL”), and boards that are a composite of strands and ply veneers. As used herein, “flakes”, “strands”, and “wafers” are considered equivalent to one another and are used interchangeably. A non-exclusive description of wood composite materials may be found in the Supplement Volume to the Kirk-Othmer Encyclopedia of Chemical Technology, pp 765-810, 6^{th} Edition, which is hereby incorporated by reference.

The present invention relates to methods of making OSL and LSL with very high wood fiber utilization rates. Conventional processes for making OSL and LSL have focused mostly on controlling strand length, particularly by using long strands such as strands of a length of 8 inches or greater and screening out and discarding shorter strands. But screening-out such a large portion of strands is so significantly inefficient that it seriously undermines the economic advantages usually associated with wood composite materials. Additionally, further reductions in lignocellulosic fiber utilization result because in conventional processes for making LSL and OSL operators have, in order to ensure that the amount of angular divergence from the straight (“machine”) direction does not exceed 10°, resorted to rigidly screening out unsatisfactorily wide or narrow strands, such as those strands having a width greater than 2 inches or less than ½ inch. Strands greater than 2 inches are unsatisfactory because they contribute significantly to strand plugging, while strands less than ½ inch are unsatisfactory because they are so small and maneuverable that they can pass through the orienting disks at wide angular deviations--well in excess of 10°.

But as a result of screening out unsatisfactory strands, the wood fiber yield of the process drops precipitously, to under 50% or less, undermining the economic efficiency of the process. In the present invention it has been discovered that by using longer strands while at the same time controlling the strand width with 3D stranding technology, then OSL and LSL products can be made that have both excellent strength and stiffness performance while also being very efficient users of lignocellulosic fibers. By using 3D stranding technology, 3D strands are formed that have a width consistently between ½ inch to 2 inches, as well as a length of between 6 inches to 12 inches, and a thickness of between 0.01 inches to 0.05 inches; using these stands allows a manufacturer to control the application of strands so that the strands have an average angular divergence of less than 10° while still making highly efficient use of the supply of lignocellulosic fiber, in fact in the present process nearly 100% of the wood strands can be used in the manufacture of the OSL/LSL.

The 3D strands are produced by cutting wood strands from wood lumber using 3D stranding technology in a 3D stranding process, which controls all three dimensions of length, thickness and width of the strands. 3D stranders and 3D stranding technology are described in greater detail in, e.g., U.S. Pat. No. 6,035,910. 3D stranders may be available from a variety of manufacturers, including, Pallmann Maschinenfabrik GmbH & Co. KG, Zweibrucken, Germany, Inter-Wood-Maschinen KG, Lechbruck am See, Germany, G. Siempelkamp GmbH & Co., KG, Krefeld, Germany and Carmanah Design and Manufacturing Inc., Vancouver, British Columbia, Canada.

(Additionally, the strands will have a thickness of between 0.01 inches to 0.05 inches which will allow the overlapping area between adjacent strands to have enough intimate contact/adhesion to transfer the shearing stress cross their interference without delaminating. This means the strands will preferably be characterized by a slenderness ratio (the ratio of the strand length to the thickness of the strands) of 200-300, resulting in improved shearing and bending capacities to the final products.

After the strands are cut using the aforementioned 3D stranding technology they are dried in an oven and then coated with a special formulation of one or more polymeric thermosetting binder resins, waxes and other additives. The binder resin and the other various additives that are applied to the wood materials are referred to herein as a coating, even though the binder and additives may be in the form of small particles, such as atomized particles or solid particles, which do not form a continuous coating upon the wood material. Conventionally, the binder, wax and any other additives are applied to the wood materials by one or more spraying, blending or mixing techniques, a preferred technique is to spray the wax, resin and other additives upon the wood strands as the strands are tumbled in a drum blender.

After being coated and treated with the desired coating polymeric binders and other chemical additives, these coated strands are used to form either single layered unidirectional wood strand/veneer (for laminated strand lumber type products) or a multi-layered mat (for oriented strand lumber type products). In the single layered mat, multi-orienters can be used to create layered mats with all strands aligned unidirectionally. For multi-layered products, the layering of strands may be done, for example, in the following fashion. The coated flakes are spread on a conveyor belt to provide a first ply or layer having flakes oriented substantially in line, or parallel, to the conveyor belt, then a second ply is deposited on the first ply, with the flakes of the second ply oriented substantially perpendicular to the conveyor belt. Finally, a third ply having flakes oriented substantially in line with the conveyor belt, similar to the first ply, is deposited on the second ply such that plies built-up in this manner have flakes oriented generally perpendicular to a neighboring ply. Alternatively, but less preferably, all plies can have strands oriented in random directions. The multiple plies or layers can be deposited using generally known multi-pass techniques and strand orienter equipment. As an example, U.S. Pat. No. 4,751,131 teaches methods for manufacturing oriented strand lumber products. In the case of a three ply or three layered mat, the first and third plys are surface layers, while the second ply is a core layer. The surface layers each have an exterior face. More commonly, four layer orienters are installed in the manufacturing process and manufactured with two face layers and two core layers.

The above example may also be done in different relative directions, so that the first ply has flakes oriented substantially perpendicular to conveyor belt, then a second ply is deposited on the first ply, with the flakes of the second ply oriented substantially parallel to the conveyor belt. Finally, a third ply having flakes oriented substantially perpendicular with the conveyor belt, similar to the first ply, is deposited on the second ply.

After the mats are formed according to the process discussed above, they are compressed under a hot press machine that fuses and binds together the wood materials, binder, and other additives to form consolidated OSB panels of various thickness and sizes. The high temperature also acts to cure the binder material as well as evaporate the moisture present in the raw material. Preferably, the panels of the invention are pressed for 2-15 minutes at a temperature of about 175° C. to about 240° C. Compression of the wood-additive may occur in a multi-platen press where several mat batches are set upon a series of press platens, and the batches compressed between adjoining platens. The platens are heated to high temperatures by passing a heating fluid through them and this heat in the platens is then dissipated as heat flows from the platens and into the mats while the mats are being compressed. The press can be a multi-platen press in which a head plate is mounted above a bed plate, which can be raised and lowered by conventional hydraulic equipment capable of generating the required pressures. Between the head plate and bed plate are multiple press platens that are positioned adjacent to and equally-spaced relative to each other and are operated by an automatic opening and closing mechanism and device. Typically, the mat is brought to the press on a conveyor system and loaded into a prepress. These mats are made from one or more layers of wood flakes, particles or chips that are coated with additives like resin binder or wax. From the prepress, the mats are charged into the hydraulic press onto press platens where the mats are compressed to produce sheets of a wood composite material or wood boards, and then loaded into a discharge apparatus for emptying the sheets formed on the platens. Multi-platen presses are discussed in greater detail in U.S. Pat. No. 4,412,801, issued to Pesch, on Nov. 1, 1983.

Various polymeric resins, preferably thermosetting resins, may be employed as binders for the wood flakes or strands. Suitable polymeric binders include isocyanate resin, urea-formaldehyde, polyvinyl acetate (“PVA”), phenol formaldehyde, melamine formaldehyde, melamine urea formaldehyde (“MUF”) and the co-polymers thereof. Isocyanates are the preferred binders, and preferably the isocyanates are selected from the diphenylmethane-p,p′-diisocyanate group of polymers, which have NCO— functional groups that can react with other organic groups to form polymer groups such as polyurea, —NCON—, and polyurethane, —NCOON—; a binder with about 50 wt % 4,4-diphenyl-methane diisocyanate (“MDI”) or in a mixture with other isocyanate oligomers (“pMDI”) is preferred. A suitable commercial pMDI product is Rubinate 1840 available from Huntsman, Salt Lake City, Utah, and Mondur 541 available from Bayer Corporation, North America, of Pittsburgh, Pa. Suitable commercial MUF binders are the LS 2358 and LS 2250 products from the Dynea corporation.

It will be appreciated by those skilled in the art that changes could be made to the embodiments described above without departing from the broad inventive concept thereof. It is understood, therefore, that this invention is not limited to the particular embodiments disclosed, but it is intended to cover modifications within the spirit and scope of the present invention as defined by the appended claims.

I claim:

1. A process for making an engineered wood product comprising the following steps:
(a) cutting a quantity of strands from wood lumber by use of a 3D stranding process, the strands having a length of about 6 inches to about 12 inches; and
(b) forming the quantity of strands into an engineered wood product.

2. The process according to claim 1, wherein the width of the strands is between about 0.5 and about 2 inches.

3. The process according to claim 1, wherein the thickness of the strands is from about 0.01 inches to about 0.05 inches.

4. The process according to claim 1, further comprising the steps of:
coating the wood strands with a binder composition to from coated strands;
forming a mat from the coated strands; and
pressing the mat, at a high temperature, to form the engineered wood product.

5. The method according to claim 4, wherein the high temperature is from about 175° C. to about 260° C.

6. The method according to claim 1, wherein the mat is formed from alternating layers, with the coated strands in adjacent layers being oriented substantially perpendicular to each other.

7. The method according to claim 1, wherein the mat is formed from layers, and in each layer the strands are aligned in substantially the same direction.

8. The method according to claim 1, wherein the engineered wood product is OSL.

9. The method according to claim 1, wherein the engineered wood product is LSL.

10. An engineered wood product comprising 3D strands having a length of about 6 inches to about 12 inches.

11. The process according to claim 10, wherein the width of the 3D strands is between about 0.5 and about 2 inches.

12. The process according to claim 10, wherein the thickness of the 3D strands is from about 0.01 inches to about 0.05 inches.
